(19) United States
(12) Patent Application Publication
(10) Pub. No.: US 2006/0165239 A1
(43) Pub. Date: Jul. 27, 2006

(54) Method for determining acoustic features of acoustic signals for the analysis of unknown acoustic signals and for modifying sound generation

(75) Inventors: Joerg Langner, Berlin (DE); Wolfgang Auhagen, Berlin (DE)

Correspondence Address: ROTHWELL, FIGG, ERNST & MANBECK, P.C., 1425 K STREET, N.W., SUITE 800, WASHINGTON, DC, 20005, US

(73) Assignee: Humboldt-Universitat zu Berlin, Berlin (DE)

(21) Appl. No.: 10/536,026

(22) PCT Filed: Nov. 12, 2003
(86) PCT No.: PCT/DE03/03738

§ 371 Date: May 23, 2005

(30) Foreign Application Priority Data
Nov. 22, 2002 (DE) 10254612.6

(51) Int. Cl. H04R 29/00

(52) U.S. Cl. 381/56; 381/94.2

(57) ABSTRACT

The invention relates to a method of determining acoustic features of sound signals indicating the presence or absence of a property of the sound signal or sound generator, it also relates to the use of the result of this determination of features for analysing unknown sound signals as to the presence or absence of a certain relevant property or for modifying the sound generation with a view to optimizing a certain relevant property.

The invention relates to a method of determining acoustic features of sound signals indicating the presence or absence of a property of the sound signal or the sound generator, it also relates to the use of the result of this determination of features for analysing unknown sound signals as to the presence or absence of a certain relevant property or for modifying the sound generation with a view to optimizing a certain relevant property.

The invention is concerned with the analysis of sound in its broadest sense. Sound in the present context is understood to be notes of music, sounds of speech, as well as tones or noises produced by human beings, animals, or articles.

Important known fields of application of sound analysis, on the one hand, are various systems of speech analysis and voice recognition as well as voice control of technical systems and also various attempts at analysing notes of music and, on the other hand, machine diagnosis. An important aspect, normally, is the degree of certainty with which a sound generator can be identified or a feature can be assigned to a tone or noise. This is true in particular of analytical methods using personal identification including the most diverse characteristics and criteria, either individually or in combination, in order to be able to characterize the sound generator or a property to be examined of the sound generator.

U.S. Pat. No. 5,425,127, for instance, discloses a voice recognition method operating with broadband filters and the envelopes of the spectra belonging to the voice signals.

A signal source characterization system for use in controlling automobile radios, handsfree telephones, cellular telephones, and the like is known from DE 695 11 602 T2. With this system, a primary signal which is to be amplified or isolated is separated from interfering signal sources. This system operates primarily with signal folding and folding mixtures and exploits the fact that the primary signal adds up whereas the interfering signal averages out.

EP 0 297 729 A2 discloses a machine diagnostic process (bearing failure detection apparatus) based on acoustics and operating exclusively with a threshold value in a single frequency range. All the apparatus does, is signal the occurrence of a loud noise upon failure of a bearing.

A special method of machine diagnosis is known from U.S. Pat. No. 6,173,613 B1, it applies a relationship between high and low frequency portions for crack detection in plate-type materials.

As far as the analysis of sounds of music is concerned examinations of the timbre may be classified in two major directions: one approach in research focusses on the sound production, whereas the other one is mainly concerned with the reception of sound, the effect of sound. In studying sound production, one major point of interest is to work out the peculiarities of the sound of groups of musical instruments, such as string instruments as distinct from other groups, and also to differentiate within the individual groups of instruments. Important sound distinguishing parameters which have been identified in such studies are:
the periodicity or aperiodicity of the time function of the sound emitted,
the envelope of the magnitude spectrum,
formants, i.e. characteristic frequencies of a sound having a relatively higher energy in the spectrum and a frequency range which is largely independent of the varying fundamental frequency,
proportions of noise
time-dependent changes of the sound spectrum in the quasi stationary section,
building-up and dying-out transients.

These then are the parameters which are essential for making groups of musical instruments distinguishable. There is no agreement amongst the reception oriented sound researchers as to the contribution of each of these parameters to the distinguishableness. For example, in evaluating time information, the role of building-up and dying-out transients is disputed. This would appear to be most dependent on the particular situation. The transients evidently do have some significance with isolated sounds and individual sound pairs.¹ G. de Poli and P. Prandoni set forth the hypothesis that building-up transients were the only feature that remained relatively constant with instrumental sounds and, therefore, was highly important for identification purposes, whereas the sound spectrum determined the individual quality of sounds.² On the other hand, an experiment conducted by Mark Pitt and Robert Crowder during which actually heard tones were to be compared with notes introduced, i.e. recalled from memory, demonstrated that the building-up transients had no influence on the judgment of similarity with which only spectral differences played a role.² The experimental results reported by Christoph Reuters on the recognizability of manipulated instrumental notes⁴ likewise suggest that the building-up transients should not be accorded too much weight.

It proved to be especially difficult to determine quality parameters for the sound of an instrument⁵. Studies on this topic, such as by Jurgen Meyer relating to guitars⁶ and pianos⁷ and by Heinrich Dunnwald relating to violins⁸ all showed that the quality of sound is not determined by isolated physical parameters but instead always by a complicated joint action of a plurality of factors, e.g. how pronounced individual resonances were, and what the level ratios were between different frequency ranges of the spectrum. Thus it was a problem of coming to grips, mathematically, with this complicated cooperation and develop a method which should be applicable to a hole variety of sounds, permitting generalizations, i.e. statements about common traits of groups of instruments, while, at the same time, allowing the detection of individual peculiarities of sounds. The methods known up to now were aimed at overcoming the problem of determining sound quality by picking the most important one or a very small number of especially important parameters from among the great number of physical parameters, i.e. practically carrying out a kind of data reduction. H. Dunnwald, for example, used a template which was placed over the graphic resonance curves of violins. On that basis, level ratios between different frequency ranges could be determined.

Conventional methods, consequently, were directed only to individual musical instruments and could not even allow for the influence of the player on the quality of the sound. Apart from considerations of principle by Jurgen Meyer⁹, very few studies have been undertaken regarding the creation of sound by an instrumentalist or a singer. Ekkehard Jost¹⁰ and Karel Krautgartner¹¹, for example, studied clarinetists and Bram Gätjen¹² studied oboists. There was thus a lack of empirical data in this field, and that made it impossible to test novel analytical methods which can process vast amounts of data.

Starting from the above, it is an object of the invention to determine those very acoustic features of a sound signal which are relevant in a particular context and, on that basis, to offer methods which make it possible to detect a relevant property which is to be examined.

To accomplish that, it is provided, in accordance with the invention, with a method of the kind mentioned initially, that the separate processing of two groups of sound signals is performed in at least the following steps:
(1) detecting the sound signals and converting them into computer readable audio data or taking over a previously recorded sound signal in the form of an audio file;
(2) generating a frequency spectrum of each sound signal;
(3) generating predictors for each of the spectra of the two groups on the basis of
   (a) the tonality of individual frequencies via determination of the sound to noise ratio,
   (b) the sums of the tonal proportions and the sums of the energy proportions, each in selected frequency bands;
(4) generating derived predictors by product formation and relations formation from the predictors;
(5) determining the acoustic features which are relevant for the sound generator property under examination by logistic regression between the two groups with at least individual ones of the predictors generated in steps (3) and (4) and derived predictors, while obtaining regression coefficients for individual predictors and derived predictors representing a measure of the relevance of the respective feature,
   the two groups each containing at least two sound signal examples, the first of the two groups containing only those examples which were obtained previously and which were assigned, by measurement or judgment, the presence of the property to be examined, and the second group containing only those examples which were obtained previously and which were assigned, by measurement or judgment, the absence of the property to be examined.

“Predictors” in the present context are understood to be value sequences (vectors) which are determined, within the method according to the invention to be explained in greater detail below, to become the basis for the granting of tone characteristics. Each of these vectors represents a certain acoustic feature. To begin with, a statistical evaluation is made based on a comparison of previously selected “positive and negative examples” to see which of all the possible predictors within the method are specifically relevant for the respective property under examination. These predictors then are used in the various applications to examine unknown sound signals for the presence or absence of the property.

Compared with conventional methods, which are similar in the widest sense only, the method according to the invention is characterized by much better utilization of the data (sound spectra) or very great compression of data, due to the determination of predictors. The treatment according to the invention of those data/spectra offers optimum exploitation of the information regarding sound quality contained in the data/spectra.

In more recent voice recognition processes, for example, great numbers of individual spectra are used (e.g. for about 4 minutes one individual spectrum every 10 ms, see pages 263 and 264 of the publication by Julia, Heck & Cheyer, 1997) as well as great numbers of acoustic features (e.g. 2048 Gaussian components, page 264 of the same publication). But the individual spectrum is not evaluated very intensively (no more than 17 Mel Cepstrum vectors per spectrum). The Technical Data Sheet of the Nuance Verifier™ 3.0 (Nuance Communications Inc., U.S.A) mentions a ‘Voiceprint’ of about 20 kB which a speaker is allocated. That corresponds to a matrix of numbers comprising several hundreds of values, thus indicating the huge number of features included. However, the enormous effort invested in data acquisition and data processing is not properly exploited, at least not in a manner comparable with the instant invention.

The method of the invention determines precisely those acoustic features of a sound signal which are relevant and needed in a certain given circumstance and in applying the method so as to automatically detect the property under examination.

With the method according to the invention, especially those acoustic features of a sound are determined which are relevant for certain psychic effects of the sound or characteristic of certain auditory impressions, such as “nice”, “clear”, “warm”, or required for identifying a source of the sound, such as a speaker, or provide information about the characteristics or conditions of the source. The opportunities offered by the method in this respect extend from the examination of properties of materials all the way to the psychic states of speakers.

Between steps (2) and (3) of the method, preferably, the fundamental tone of each spectrum is determined and, where a fundamental tone is present (in the analysis of sounds or signals with clearly tonal portions), the spectrum is transposed to a reference tone so that there will be a set of non-transposed spectra and a set of transposed spectra for each of the two groups. Steps (3) to (5) then will be applied to the non-transposed spectra and the transposed spectra.

In further developing the invention, the results obtained in step (5) may be indicated, for instance, by being displayed numerically or graphically. If not, they will be stored prior to their further processing. An opportunity which suggests itself would be to implement the method according to the invention in a compact device, including microphones for recording sound signals, processing data, software, an integrated monitor or integrated display. The invention likewise may be embodied in the form of a method which is carried out on existing equipment or within larger units.

The invention will be explained in greater detail below with reference to the sequence of the individual steps:

Definitions:

The “property of a sound signal” is understood to be the property which is relevant in a particular context, especially for solving a problem. Properties in this sense are, for example, that listeners find a sound of music “nice”, that a voice signal is that of a very specific speaker, that a running noise comes from a faulty machine.

The “acoustic features of a sound signal” are to encompass the totality of all physical characteristics of a sound signal. Acoustic features in this sense are, for example, the added sound energy within a certain frequency band, the relationship between the added sound energies of various frequency bands, the proportion of noise within a certain frequency band.

“Sound” is understood in its broadest sense. It comprises in particular notes of music, sounds of speech, tones of animals, noises made by articles.

The limits of the frequency range that is audible by human beings need not necessarily be observed. Nor is the method necessarily limited to sound which propagates in air.

Further definitions of terms will be given as the description of the individual steps progresses.

Step (1)

The starting point for application of the method according to the invention always is a concrete problem to be resolved, stating which property of a sound signal is to be examined. Prior to applying the method of the invention, therefore, a number of audio recordings of sound signals are obtained and assigned to two categories, either by evaluation or measurement.
1.) Pro-Examples: in which the relevant property is present (e.g. examples of the “nice” sound of a musical instrument, of the voice of a speaker to be identified, of running noises of a faulty machine)—(first group of sound signal examples)
2.) Contra-Examples: in which the relevant property is absent (e.g. samples of the non-“nice” sound of a clarinet, of the voice of other speakers, of the running noise of a perfectly operating machine)—(second group of sound signal examples).

The totality of pro- and contra-examples will be referred to below under the common designation of examples or sound examples. All examples at first are treated alike in the successive steps of the analysis. A distinction between the two groups need not be made in the treatment before the logistic regression step.

The selection of the examples must be adapted to the problem to be resolved. Apart from the one relevant property, usually, the pro-examples should be as different as possible. (For instance, the “nice” clarinet tones should be played on different instruments and by different musicians. In the voice examples, the speaker to be identified should be presented by different words.) The same principle of the greatest possible differences applies to the selection of contra-examples.

Preparatory measures may be required for collecting the examples, such as a musical psychological experiment polling listeners to find out which tones they consider “nice”. In the case of the machine diagnostic procedure, the actual condition of a number of machines would have to be found out by non-acoustic testing.

The number of examples needed depends on the problem to be resolved, especially on the difficulty of the task and the desired reliability of the method. Typically at least two examples, preferably, however, at least ten, and better still fifty examples, should be used.

The examples will have to have time lengths of from 300 to 1000 ms, especially from 400 to 500 ms. If existing recordings of sound signals are longer, shorter parts may be cut out.

The sound recordings of the examples chosen may be employed in any form (e.g. as audio cassette or audio CD). If necessary, they will be digitized and converted into a computer readable version (e.g. data in WAV audio format).

The conversion is conventional and can be executed by most commercially available PC sound cards, for example.

As a result of the first step, a computer readable audio file will be available for each of the pro- and contra-examples which were selected for the particular problem to be resolved.

All the actions taken in the first step are conventional, they are methods known in the art so that a person skilled in the art can readily prepare the sound signals for examination. Also the separation into pro- and contra-examples is a conventional procedure (see e.g. DE 19 630 109).

Step (2)

The computer readable audio files are used as input in a spectrum analysis process. The spectrum analysis can be performed also by numerous conventional audio analysis operations, mainly by FFT, Fast Fourier Transformation (e.g. “Viper”® by Messrs. Cortex Instruments). A spectrum thus is obtained for each one of the sound examples, in practice being a sequence of numbers Sₖ (and k=0 . . . kx), each Sₖ indicating a measure of the intensity/energy by which a sinusoid of the frequency Fₖ is represented in the sound signal of the example concerned. The frequencies Fₖ depend on the resolution Δf selected. Thus
Fₖ=Δf·k.

As the resolution, maximum frequencies, and frequency bandwidth all are variable they need to be adapted to the requirements of the case at issue.

In principle, these values—resolution, maximum frequencies, number of value pairs, and frequency bandwith—are variable and to be adapted to the respective requirements. Whenever a task involves the examination of properties which are sensed subjectively by listeners, the upper performance limits of human perception must be taken into account (as regards the maximum frequency, for instance, the value of 20000 Hz should not be gone very much beyond). When problems to be resolved concern the detection of features of objective properties these limits may and sometimes must be surpassed, both as regards the frequency resolution Δf and the upper limit frequency Fₖₓ.

Preferably, the frequency spectra are standardized to a common minimum and a common intensity mean value. In a preferred embodiment, each of the sequences of numbers Sₖ supplied by the audio analysis program for each example is subjected to standardization by two calculation steps:
(a) Separately for each example, a certain constant magnitude is added to or subtracted from each of the Sₖ such that the minimum of the resulting modified Sₖs will be zero.
(b) Subsequently, all values are multiplied by a certain constant factor such that the average value across all values will be the same for all examples.

The sequence of numbers available after the second processing operation will be identified below by the letter A.

Since there is such a standardized spectrum comprising k values for each of the i examples an overall matrix is obtained as follows:
A_{i,k} (i=1 . . . ix and k=0 . . . kx).

Adding index l to the lines and k to the columns, each line of this matrix corresponds to one of the total of ix spectra (which were standardized according to sub-steps (a) and (b) above).

All operations of the second step of spectrum analysis and standardization are methods with which those skilled in the art are familiar, which they can choose and modify, if necessary, based on their expert knowledge.

Step (3)

Each of the spectra, first, is subjected to the two procedures discussed below.
(a) A measure is calculated for each frequency Fₖ to determine by how much the associated amplitude value surpasses the amplitudes of the neighboring frequencies. This might be called a measure of “tonality” of the respective frequencies because a very much pronounced frequency is perceived by the human ear as a “tonal” portion of sound, as against all the other, the “noisy” portions.
A value TONₖ between 0 and 1 is determined for each index (frequency value) k. It is a measure of the tonality of the associated sine component. The values TONₖ, preferably, are standardized so that their minimum will be 0 (meaning: purely noisy portion) and their maximum will be 1 (meaning: clearly tonal portion, pure sinusoids).
(b) In the event that the sound to be examined is sound which has a definable fundamental tone (as is the case with almost all tones of musical instruments and in the sonant portion of speech, but also in many machine running noises) the spectrum, optionally, is transposed in addition to a selected reference tone F_{ref}. To accomplish that, the frequency F_{orig} of the fundamental tone contained in the original signal must be found out first. That can be done by resorting to existing software (e.g. “Viper” by Cortex Instruments). Once the frequency of the original fundamental tone is known, the following can be calculated
   aₜᵣₐₙₛ=F_{ref}/F_{orig}.
   Subsequently, all frequencies Fₖ of the original spectrum are multiplied by the transposition factor aₜᵣₐₙₛ
   FTₖ=aₜᵣₐₙₛ·Fₖ (k=0 . . . kx).

In this manner, a second spectrum is obtained with the same amplitudes Aₖ, yet with frequencies FTₖ belonging to these amplitudes.

Next, the energy portions within certain frequency bands are to be added. That makes it necessary, first, to define these frequency bands, as regards their width, number, and absolute position.

Width:

It may be advantageous for music and voice applications to work with logarithmically equidistant bands, i.e. the frequency centers of two successive bands (indicated in Hz) always have the same relationship r with respect to each other. Dividing an octave (in other words a range having a frequency ratio of 2:1) into d logarithmically equidistant bands results in r=2^{(1/d)}. In a preferred embodiment d=4 was used or “minor third bands”, to put it in musical terms.

Number:

At least 5, preferably at least 15, more preferably at least 20 frequency bands per sound signal are used.

Position:

The lowest band center for the transposed spectra is positioned such that even a range below a fundamental tone of approximately 185 Hz is covered.

The frequency band belonging to a center frequency then extends to the surroundings of the center of the frequency, with a radius each of one half the center spacing. The exact mathematical formulation will be found below in the equations for forming the sums of the bands.

The band sums of specified bands, i.e. the additions of the energy portions lieing within a band, next are formed for each of the examples to be analyzed and for each of the two spectra.
N_{i,m}=Sum[A_{i,k}, {k|Ln[MNₘ]−Ln[d]<Ln[Fₖ]≦Ln[MNₘ]+Ln[d]}]/(number of summands)
for (i=1 . . . ix and m=1 . . . mNx)
T_{i,m}=Sum[A_{i,k}, {k|Ln[MTₘ]−Ln[d]<Ln[FTₖ]≦Ln[MTₘ]+Ln[d]}]/(number of summands)
for (i=1 . . . ix and m=1 . . . mTx)
N_{—}TON_{i,m}=Sum[TON_{i,k}, {k|Ln[MNₘ]−Ln[d]≦Ln[Fₖ]≦Ln[MNₘ]+Ln[d]}]/(number of summands)
for (i=1 . . . ix and m=1 . . . mNx)
T_{—}TON_{i,m}=Sum[TON_{i,k}, {k|Ln[MTₘ]−Ln[d]<Ln[FTₖ]≦Ln[MTₘ]+Ln[d]}]/(number of summands)
for (i=1 . . . ix and m=1 . . . mTx)

These four matrices, referred to below as “basic matrices”, thus provide the following for each of the examples:
the band sums of the non-transposed spectrum (N)
the band sums of the transposed spectrum (T)
the band sums of the tonal portions of the non-transposed spectrum (N_TON)
the band sums of the tonal portions of the transposed spectrum (T_TON)

(The expression “basic” is not used here as in the mathematical expression “basis of a vector space” but rather as meaning the “foundation” on which all other calculations are based.)

The column vectors in these basic matrices will be referred to below as “basic predictors”. As they originate from the basic matrices, there are four types of basic predictors (N, T, N_TON, T_TON). Each of these types forms a predictor group.

A basic predictor, for example, is the column vector consisting of the added energy portions in the third frequency band of the non-transposed spectrum. Considering the fact that the adding is carried out separately for all the sound examples given, the basic predictor consists of a total of ix elements, all of which are different, as a rule.

Step (4)

New, combined predictors are calculated in two ways from these basic predictors. A preferred embodiment of this operation will now be described.

I.) The products of basic predictors. The product is formed linewise (i.e. for each of the examples), e.g. the product of the third and fourth band sums of the non-transposed spectrum:
ProN03_{—}04ᵢ=N_{i,3}·N_{i,4} (i=1 . . . ix)
or the product of the tonal portions of the fifth and twelfth band sums of the transposed spectrum:
ProT_{—}TON_{—}05_{—}12ᵢ=T_{—}TON_{i,5}.T_{—}TON_{i,12} (i=1 . . . ix).

If, for instance, one were to form all the two's products possible within the N group, a new group of predictors would result, namely the group of all N product predictors, or briefly: the group of all N products.

This product formation is carried out for all four types of basic predictors and, therefore, the groups will be obtained of all

1. N-products

2. T-products

3. N_TON-products

4. T_TON-products.

II.) The relationships between basic predictors. In analogy to the product formation, the following relations are formed, for example:
RelN03_{—04}ᵢ=N_{i,3}/N_{i,4} (i=1 . . . ix).

If, for instance, one were to form all the two's relations possible within the N group, another group of predictors would result, namely the group of all N-relation predictors, or briefly: the group of all N-relations.

This relation formation is carried out for all four types of basic predictors and, therefore, the groups will be obtained of all

1. N-relations

2. T-relations

3. N_TON-relations

4. T_TON-relations.

In this example, the result of the fourth step thus is another eight groups of predictors:

the four groups of products

the four groups of relations.

The information contained in a single spectrum thus is evaluated very intensively by the provision of four groups of basic predictors (step 3) and eight groups of combined predictors (step 4).

Step (5)

Next, data adaptation is performed by way of logistic regression. Logistic regression is a customary calculating operation offered by numerous statistics programs (e.g. by SPSS). This method serves to calculate to what extent a dependent variable can be “explained” from a sequence of independent variables, in other words be traced back to the same.

The dependent variable in this case is a sequence of numbers Vᵢ (i=1 . . . ix) containing the coding whether the property to be examined is present or absent in the respective example. For all i=1 . . . ix the setting is as follows:

Vᵢ=1 if the property is present

Vᵢ=0 if the property is absent.

Therefore, this is where the distinction between examples and counterexamples begins to play a part again.

Any predictors obtained from steps (1) through (4) may be used as independent variables for the logistic regression. The respective suitability for resolving the problem posed, i.e. for “explaining” the property in question, is examined by individual regression calculations on groups of predictors.

An approved method so far has been the “forward” method in combination with an entry criterion of 0.1 and an exclusion criterion of 0.05 (the latter meaning that predictors will not be included in the solution unless their contribution on the 5% level is statistically relevant). As a rule, the number of predictors actually drawn upon for the solution is reduced dramatically because of the entry/exclusion criteria and significance requirements (to less than one third of the predictors “offered” for the process).

The respective “success” may be quantified by various adaptation measures which the statistics programs supply. Up to now, use was made predominantly of the SPSS magnitude “Nagelkerkes r²” which can be interpreted, upon multiplication by 100, as a kind of “variance clarification in %”.

In executing these calculations the groups of predictors that are especially successful become clear. Considering the problems to be resolved thus far, these were the group of N-predictors, the group of N-products, the group of T-products, and the group of N_TON-predictors.

The most successful predictor groups are to be combined (several variants having to be tested) and in this way the optimum solution is to be found. The optimum solution is the one which achieves the maximum variance clarification among the given pro- and contra-example data in a cross validation, the only predictors included being those which are statistically relevant at least at the 5% level.

Furthermore, it should be tested whether some individual predictors might be eliminated from the chosen predictor groups without substantial (more than 1% of the variance clarification) deterioration of the result. As a rule, this will lead to “leaner” solutions which are preferable over the more expensive ones.

The result of the regression which will be subjected to further processing are the selected predictors and the associated regression coefficients. If px predictors Pₚ (p=1 . . . px) were selected the result will be a coefficient βₚ (p=1 . . . px) for each of these predictors. Additionally, there will be β₀ as the coefficient for the constant. (Note that a predictor is to be understood as being a column vector and, therefore, all the predictors in fact form a matrix P_{i,p} (i=1 . . . ix and p=1 . . . px), as represented above by the abbreviation Pₚ.)

The result of step (5) is embodied by the result of the regression calculation.

Example A is an example of the result of such regression calculation.

In principle, the invention makes use of the regression calculation in two ways:

The regression coefficients and their associated predictors may be drawn upon for predicting whether a new sound signal, not yet examined, possesses a relevant property to be examined which was assigned to the first group of sound signals as being present and to the second group as being absent, based on the determination of features.

The sound signal may be a tone, note, noise, or body sound, especially a vibration, a signal generated by a human voice, or a sound signal brought forth by a machine or technical device.

The property to be examined especially may be a psychic effect of a tone, note, or noise, such as “nice”, “warm”, “pleasant”, “cheerful”, etc. The examples of sound signals of the first group are ones which are assigned this property by judgment, whereas the examples of sound signals of the second group are ones which are expressly not assigned this property.

In an embodiment of the invention the sound signal examples of the first group are those of a certain speaker to be recognized and the sound signal examples of the second group are those of at least one other speaker. The property chosen for investigation is the identity of the speaker.

The method according to the invention, moreover, may be helpful in the construction of control instruments by which it is checked whether or not and, if so, to what extent the acoustic features are given in sound signals emanating from certain sound generators. The method according to the invention is very well suited, among others, for machine diagnosis. The operating noise of a machine which functions perfectly can be compared with the sound of a similar machine under examination. Any deviations will be recognized at once. If examples (“negative” examples) of the sound occurring with specific faulty machine operations are recorded it is even possible, as a rule, to attribute the type of fault to the sound. Speed is one of the advantages of this method as compared to other methods of examination and, for this reason, the method is suitable also for continuous monitoring of machines. The method according to the invention may be applied similarly in materials testing. In this context, desirable properties of materials can be correlated with sound characteristics. The respective workpiece is excited so as to emit a sound, and the sound thus generated in the testing procedure is examined with a view to the specifically relevant acoustic features.

Finally, the method according to the invention may be used for iterative verification when sounds are generated with a certain desired effect.

The applications of the feature analysis procedure according to the invention will be described in greater detail below with reference to examples of use; they are characterized in the claims.

As stated above, the result of the determination of features by means of the method according to the invention is used for analysing an unknown sound signal with respect to the property or properties which the first group of sound signals was assigned as presenting and the second group was assigned as not presenting, based on the determination of features.

Analysis of Unknown Sound Signals

The point of departure is a new sound signal which was not examined before. The method is devised so that it can be determined with respect to this sound signal whether a certain relevant property is given or not. For example, it is to be found out whether a tone of music will be perceived as “nice”, whether a voice signal originates from a certain speaker, or whether a running noise is that of a faulty machine.

To accomplish that, the sound signal or, more specifically, a section 400 to 500 ms long of the signal must be examined in the same way as the pro- and contra-examples. Thus the procedure of steps 1 to 3 is carried out:
(1) The tone recording is converted into a computer readable file.
(2) The (original) spectrum of this file is calculated.
(3) That is used to form the two spectra (non-transposed and transposed). Based on the two spectra, the band sums are calculated. Thus a value each is obtained for each of the basic predictors for the example under examination. That may then be used to calculate the values for each of the composite predictors (in other words, an (ix+1)th value is calculated for each of the predictors which, up to now, each consisted of ix values.

Px significant predictors had been determined as the result of the third step. Let
Pvalueₚ (p=1 . . . px)
be the values of the example to be examined for these predictors.

Then the probability W of the new sound signal possessing the relevant property is calculated according to the central equation of the logistic regression, taking recourse to the auxiliary quantity H¹³, from:
H=Exp[Sum[βₚ·Pvalueₚ,{p|p=0 . . . px}]].
Pvalue₀=1 is set.
W=H/(1+H).

If this probability is greater than a selectable quantity c (0<c<1) it is predicted that the relevant property is given. The suitable choice of c depends on the concrete problem to be resolved and on the specific situation. As a rule, c=0.5 will be set. A higher value of c reduces the error probability of an erroneous prediction of “property given”, but it increases the error probability of an erroneous prediction of “property not given”. A value of c below 0.5 produces the opposite effect.

Application for Generating or Modifying Tones

In the regression, the predictors Pₚ(p=1 . . . px) were determined to be statistically relevant for predicting a certain sound property, and they were assigned a positive or negative β-coefficient.

Since concrete sound features are associated with the individual predictors (e.g. predictor N₃ belongs to the energy added up in the third frequency band of the non-transposed spectrum) conclusions for generating or modifying sound which has the sound property in question may be derived from the regression. The sound generator is to be designed or modified in such a way that the features provided with positive β-coefficients for a are reinforced, while those features provided with a negative β-coefficient are weakened.

Regression Analysis

SPSS Expression “Logistic Regression Fg1/Fg”

The problem to be resolved was to determine those acoustic features by which bassoonist no. 1 can be identified amongst all bassoon examples. 88 tone examples of this bassoonist (pro-examples) and 129 other bassoon examples (contra-examples) were used as the basis.

Table 1 among others includes the quantity “Nagelkerkes R square”. As already explained, this is a measure of the success of adaptation. The classification table (table 2) demonstrates that 78 of the 88 Fg1 examples are correctly attributed to the bassoonist (88.6%) and that 122 of the 129 non-Fg1 examples are correctly allocated as non-Fg1 (94.6%).

Table 3 shows that a total of 12 predictors plus the constant for regression were drawn upon. These are listed in column 1.

TP_{—}01.11 represents the predictor obtained from the product of the first and the eleventh band sums of the transposed spectrum;

N_{—}01 represents the predictor consisting of the first band sum of the non-transposed spectrum;

N_TON_{—}05 represents the predictor consisting of the tonal portions of the fifth band sum of the non-transposed spectrum.

Column 2 lists the corresponding β-coefficients.

TABLE 1

| | −2 Log- | Cox & Snell | Nagelkerkes |
|---|---|---|---|
| step | Likelihood | R-square | R-spare |
| 14 | 88.445 | .610 | .824 |

TABLE 2
(classification table^{a})

predicted

| | |
|---|---|
| FG_1 | percentage of |

| observed | | | 0 | 1 | correct ones |
|---|---|---|---|---|---|
| step 14 | FG_1 | 0 | 122 | 7 | 94.6 |
| | | 1 | 10 | 78 | 88.6 |

| | |
|---|---|
| overall percentage | 92.2 |

^{a}The separating value reads .500

TABLE 3
(variables in the equation)

| | | regression | standard | | | | |
|---|---|---|---|---|---|---|---|
| | | coefficient B | error | Wald | df | Sig. | Exp(B) |
| step | Tp_01.11 | .887 | .271 | 10.711 | 1 | .001 | 2.427 |
| 14 | Tp_02.03 | −1.732 | .413 | 17.621 | 1 | .000 | .177 |
| | Tp_02.07 | .560 | .313 | 3.212 | 1 | .073 | 1.751 |
| | Tp_05.14 | −2.091 | .513 | 16.628 | 1 | .000 | .124 |
| | N_01 | .125 | .086 | 3.417 | 1 | .065 | 1.133 |
| | N_07 | −.898 | .182 | 24.352 | 1 | .000 | .407 |
| | N_10 | 1.449 | .256 | 32.058 | 1 | .000 | 4.258 |
| | N_12 | −1.119 | .206 | 29.559 | 1 | .000 | .327 |
| | N_TON_05 | −18.127 | 6.137 | 8.723 | 1 | .003 | .000 |
| | N_TON_06 | −22.219 | 6.335 | 12.301 | 1 | .000 | .000 |
| | N_TON_07 | 17.849 | 7.989 | 4.992 | 1 | .025 | 56465110 |
| | N_TON_09 | 64.054 | 12.819 | 24.967 | 1 | .000 | 6.58E+27 |
| | constant | 16.084 | 5.664 | 8.064 | 1 | .005 | 9663162.9 |

### EXAMPLES

### In General

Number of examples: In applications so far we worked with approximately 60 pro- and 130 contra-examples when identifying a certain musical expression, approximately 40 pro- and 140 contra-examples when identifying a certain musician.

Resolution

Δf=2.69160 Hz

k×=8 129

in the analysis of musical tones.

The maximum frequency chosen in applications so far was

Fₖₓ=22 046.90 Hz

constant standardization factor: 60.

(For voice analysis, largely the same parameter settings are recommended, however, the upper limit of frequency Fₖₓ may be cut in half and, therefore, also the value of kx may be reduced to 4065.)

Calculation of the tonality, for instance, by means of the attached “Mathematica Programm”; result 0<TONₖ<1.

F_{ref}=185 Hz

frequency bands:

width: logarithmically equidistant frequency bands, d=4 (minor third bands)

number:

mNx=23 for the non-transposed spectra

mTx=18 for the transposed spectra

position:

center frequencies (in Hz) so far selected for non-transposed spectra:
MNₘ=370·2^{(1/4).(m-1)} (m=1 . . . mNx)
for transposed spectra:
MTₘ=370.2^{(1/4).(m-1)} (1 . . . mTx).
Mathematica Program
Mathematica Program for Calculating the Tonality of a Certain Frequency in a Given Spectrum

F[[k]] are assumed to be the frequencies of the spectrum (k=1 . . . kx) with a frequency resolution dF (in the text: Δf) of 13.4548/5 Hz.

dF=13.458/5.;

F=Table [dF*(k−1), {k, k×}]

The index limits of the range drawn upon for calculating the tonality of each frequency F[[k]] (naming them kTonOber and kTonUnter) are calculated for each k by resorting to the quantities IntervallFaktorInnen and IntervallFaktorTonInnen to be determined previously:

IntervallFaktorTonInnen = 6/5; TonInnenLog = N
[Log[IntervallFaktorTonInnen]];
IntervallFaktorTonAussen = 5/4; TonAussenLog = N
[Log[IntervallFaktorTonAussen]];
GrenzenTon[k_] := Module [{Obergrenze, Untergrenze, kTonOber,
kTonUnter},

Obergrenze = F[[k]] * N [IntervallFaktorTonAussen];
Untergrenze = F[[k]] / N [IntervallFaktorTonAussen];
kTonUnter = Min[kx, Ceiling[Untergrenze/dF] + 1];
kTonOber = Min[kx, Floor[Obergrenze/dF] + 1];
{kTonUnter, k, kTonOber}
];

kTonUnter = Table[ GrenzenTon[k][[1]], {k, kx}];
kTonOber = Table[ GrenzenTon[k][[3]], {k, kx}];
kTonDiff = kTonOber − kTonUnter;
A[[k]] are assumed to be the amplitudes belonging to the frequencies
F[[k]] (k = 1 . . . kx).

The amount of “predominance” of a frequency over the surroundings is calculated with the aid of the functions Gton[x] and NV[k] and then from:

GTon [x_] :=Which[

x < TonInnenLog, 1,
x < TonAussenLog, (TonAussenLog−x) /
(TonAussenLog−
TonInnenLog),
x = x, 0 ];

NV[k_] := If[

kTonDiff[[k]] = 0, 0.,
Sum[GTon[Abs[Flog[[k]] − FLog[[kk]]]]
*(A[[k]]−A[[kk]]),

{kk, kTonUnter[[k]], kTonOber[[k]]}]
/Sum[GTon[Abs[FLog[[k]] − FLog[[kk]]]], {kk,
kTonUnter[[k]],
kTonOber[[k]]}]

];

Ton = Table [ If[k = 1, 0., NV[k]], {k, kx}];

Therefore, each value Ton[[1]] (k=1 . . . kx) indicates by how much a frequency F[[k]] exceeds its neighborhood by its own amplitude A[[k]].

The sigmoid function SigmoTon[x] is now applied to the Ton [[1k]] and that provides values between 0 and 1.

XNullSigmoTon = 15; xEinsSigmoTon = 22; δSigmoTon = 0.25;

SigmoTon[x_] := Module[{xNull, xEins, δ, xHalb, A, B, r, c},

xNull = XNullSigmoTon;
xEins = xEinsSigmoTon;
δ = δSigmoTon;
xHalb = 0.5 * (xNull + xEins);
A = Log [1/(1−5)−1];
B = Log [1/δ−1];
r = xHalb * (B−A) / (xEins * B − xNull * A);
c = −A/ (r * xEins − xHalb);
1/ (1 + Exp[−c * (r * x − xHalb)])
];

TON = Table [SigmoTon[[k]]], {k, kx}];

These values TON[[k]] (k=1 . . . kx) are the measure of the tonality of a frequency F[[k]], as used in the method.

The features disclosed in the specification above and in the claims may be significant to implementing the invention in its various embodiments both individually and in any combination.

### LIST OF PUBLICATIONS

¹Paul Iverson, Auditory stream segregation by musical timbre: effects of static and dynamic acoustic attributes, in: Journal of Experimental Psychology, Human Perception and Performance 21,4 (1995), pp. 751-763.
²Giovanni de Poli and Paolo Prandoni, Sonological models for timbre characterization, in: Journal of New Music Research 26 (1997), pp. 170-197.
³Mark A. Pitt and Robert G. Crowder, The role of spectral and dynamic cues in imagery for musical timbre, in: Journal of Experimental Psychology, Human Perception and Performance 18,3 (1992), pp. 728-738.
⁴Christoph Reuter, Der Einschwingvorgang nichtperkussiver Musikinstrumente (=Europäische Hochschulschriften, series XXXVI, vol. 148), Frankfurt/Main 1995; id., Die auditive Diskrimination von Orchesterinstrumenten (=Europäische Hochschulschriften, series XXXVI, vol. 162), Frankfurt/Main 1996.
⁵cf. also: Jürgen Meyer, Die Pproblematik der Qualitätsbestimmung bei Musikinstrumenten, in: Instrumentenbau—Musik International 31, 1977, pp. 241-248.
⁶⁶Jürgen Meyer, Akustik der Gitarre in Einzeldarstellungen, Frankfurt/Main 1985.
⁷Jürgen Meyer and Werner Lottermoser, Über die Möglichkeiten einer klanglichen Beurteilung von Flügeln, in: Acustica 11, 1961, pp. 291-297; Klaus Wogram and Jurgen Meyer, Akustische Untersuchungen an Klavieren: 2. Qualitätsbestimmung durch Hörtests, in: Das Musikinstrument 29, 1980, pp. 1432-1441.
⁸Heinrich Dünnwald, Die Klangqualität von Violinen unter besonderer Berucksichtigung der Herkunft der Instrumente, in: Zum Streichinstrumentenbau des 18. Jahrhunderts. Bericht über das 11. Symposium zu Fragen des Musikinstrumentenbaus, Michaelstein, 9.-10. November 1990, Michaelstein 1994, pp. 71-82.
⁹Jürgen Meyer, Physikalische Aspekte des Geigenspiels. Ein Beitrag zur modernen Spieltechnik und Klanggestaltung. Siegburg 1978; id., Physikalische Aspekte des Querflötenspiels. Das Instrumentalspiel, edited by Gregor Widholm and Michael Nagy, Vienna, Munich 1989, pp. 77-96.
¹⁰Ekkehard Jost, Akustische und psychometrische Untersuchungen an Klarinettenklängen (=Veröffentlichungen des Staatl. Instituts für Musikforschung PK, vol. 1) Cologne, 1967.
¹¹Karel Krautgartner, Untersuchungen zur Artikulation bei Klarinetteninstrumenten im Jazz, typewritten dissertation, Cologne 1982.
¹²Bram Gätjen, Qualitätsmerkmale von Oboenklängen, in: Flöten, Oboen und Fagotte des 17. und 18. Jahrhunderts (=Bericht uber den 1. Teil des 12. Symposiums zu Fragen des Musikinstrumentenbaus Michaelstein, 8./9. November 1991), Michaelstein 1994, pp. 77-85.
¹³Hosmer, D. W. & Lemeshow, S. (2000), Applied Logistic Regression, Second Edition, New York: John Wiley & Sons.
¹⁴Julia, L. E., Heck, L. P., Cheyer, A. J. (1997), “A speaker Identification Agent”, Proceedings of the AVBPA-Tagung 1997, Crans Montana, Switzerland, pp. 261-266.

1. A method of determining acoustic features of sound signals indicating the presence or absence of a property of the sound signal or the sound generator, characterized by separately processing two groups of sound signals in at least the following steps:
(1) detecting the sound signals and converting them into computer readable audio data or taking over a previously recorded sound signal in the form of an audio file;
(2) generating a frequency spectrum of each sound signal;
(3) generating predictors based on the spectra of the two groups on the basis of the energy proportions in selected frequency bands, this being done each
(a) for the overall spectra and/or
(b) for the tonal portions of the spectra;
(4) generating derived predictors by forming products and relations from the predictors;
(5) determining the acoustic features, which are relevant for the sound generator property under examination, by logistic regression between the two groups with at least individual ones of the predictors generated in steps (3) and (4) and derived predictors, while obtaining regression coefficients for individual predictors and derived predictors representing a measure of the relevance of the respective feature, the two groups each containing at least two sound signal examples, the first of the two groups containing only those examples which were obtained previously and which were assigned, by measurement or judgment, the presence of the property to be examined, and the second group containing only those examples which were obtained previously and which were assigned, by measurement or judgment, the absence of the property to be examined.

2. The method as claimed in claim 1, characterized in that, between steps (2) and (3), the fundamental tone of each spectrum is determined and, where a fundamental tone is present, the spectrum is transposed to a reference tone, whereby a set of non-transposed spectra and a set of trans-posed spectra will be given for each of the two groups, steps (3) to (5) then being applied to the non-transposed spectra and the transposed spectra.

3. The method as claimed in claim 1, characterized in that the results of step (5) are indicated, preferably being displayed numerically or graphically.

4. The method as claimed in claim 1, characterized in that the frequency spectra generated in step (2) are expressed by k value pairs due to the signal intensity above the frequency Sₖ(Fₖ).

5. The method as claimed in claim 1, characterized in that the frequency spectra generated in step (2) are standardized to a common minimum and a common mean value.

6. The method as claimed in claim 1, characterized in that the tonality of the signals of the individual frequencies is determined by finding out by how much the associated amplitude value exceeds the amplitudes of the neighboring frequencies.

7. The method as claimed in claim 1, characterized in that the frequency bands are logarithmically equidistant, in the case of sound examples, preferably, having the width of a minor third.

8. The method as claimed in claim 1, characterized in that at least 5, preferably at least 15, more preferably at least 20 frequency bands are used per sound signal.

9. The method as claimed in claims 1, characterized in that the sound signals have a length of approximately 300 to 1000 ms or are shortened to that length.

10. Use of the result of the determination of features by the method as claimed in claim 1 for analysing an unknown sound signal as to the property which was assigned, by the determination of features, as being present in the first group of sound signals and as being absent from the second group.

11. The use as claimed in claim 10, characterized in that the sound signal is a tone, note, noise, or body sound, especially a vibration, a signal produced by human speech or a sound signal caused by a machine or technical device.

12. The use as claimed in claim 10, characterized in that the property to be examined is a psychic effect of a tone, note, or noise, especially the property “nice”, “warm”, “pleasant”, “cheerful”, and that the sound signal examples of the first group are ones which are attributed this property by judgment, whereas the sound signal examples of the second group are ones which specifically are not attributed the respective property.

13. The use as claimed in claim 12, characterized in that the sound signal examples of the first group are ones of a certain speaker, singer, or instrument to be recognized, while the sound signal examples of the second group are those of at least another speaker, the property to be examined being the identity of the speaker, singer, or instrument.

14. The use of the method as claimed in claim 1 for the construction of control instruments which check whether and to what extent the acoustic features are given in the sound signals emanating from certain sound generators.

15. The use of the method as claimed in claim 1 for iterative verification in the generation of sounds having a certain desired effect.

16. A computer readable data medium storing a data structure which was generated by a method as claimed in claim 1.

17. A computer readable data medium carrying a coded program for performing a method as claimed in claim 1.

18. A apparatus for carrying out the method as claimed in claim 1, characterized by
at least one microphone to record the sound signals,
at least one fixed or external storage unit containing a data processing program for performing the method stored on a data medium,
at least one at least one display device to indicate the results obtained by the method.

19. Apparatus of claim 18, wherein the apparatus is used for analyzing an unknown sound signal as to the property which was assigned, by the determination of features, as being present in the first group of sound signals and as being absent from the second group.
